(19) United States
(12) Patent Application Publication
(10) Pub. No.: US 2010/0220690 A1
(43) Pub. Date: Sep. 2, 2010

(54) DIRECT LINK ESTABLISHMENT FOR WIRELESS NETWORKS

(75) Inventors: Jakub Majkowski, Helsinki (FI); Naveen KAKANI, Irving, TX (US)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/394,845

(22) Filed: Feb. 27, 2009

(51) Int. Cl. H04J 3/00

(52) U.S. Cl. 370/336

(57) ABSTRACT

Method, apparatus, and computer program product embodiments are disclosed to improve establishing direct links in the Contention Based Period (CPB) of the MAC superframe. Embodiments of the invention enable scheduled and unscheduled data delivery modes (DDM) for a Contention Based Period. Embodiments of the invention reuse capabilities of the private basic service set (PBSS) Control Point (PCP) device like polling during the announcement time (AT) period in order to identify stations that want to initiate data transmission with other stations. That knowledge is further used by the control node (PCP) to facilitate training procedure between stations through the Contention Based Period (CPB) period or Dynamic service period (SP) periods. The behavior of stations within those periods is divided in two phases: the training phase, referred to as the Beamforming Training Time (BFTT) and data schedule negotiation phase referred to as the Data Delivery Mode Negotiation Time (DNT). Within the training phase, stations learn in which direction they should point their antennas and during the negotiation phase, a decision on data delivery mode is taken. Data delivery modes include mechanisms such as unscheduled delivery, scheduled delivery, or always on delivery. The phases may occur directly, one after the other, or they may be separated in time. Typically, training phase (if needed) should occur before the data negotiation phase. The beginning of the training phase or data negotiation phase (if training phase is not needed) is indicated via a meeting point.

### FIELD

The field of the invention relates to wireless communication and more particularly to establishment of a direct link between nodes in a network managed by a control node.

### BACKGROUND

Recent interest in the development of very high-speed wireless networks for short range communication has been fueled by the increase in emerging broadband applications such as a wireless high-definition multimedia interface (HDMI), gaming interfaces, high-speed backhaul and content distribution services, etc. The 60 GHz millimeter band (mmWave) has been targeted for the implementation of such high speed and/or capacity wireless networks due to the worldwide availability of huge unlicensed spectrum in this band. For example, emerging very high throughput wireless local area network (VHT WLAN) standards are currently aiming at very high throughput targets over multiple Gbps data rates.

However, there are many challenges to implementing an architecture in the mmWave band. For example, potential radio designs will be impacted by link budget constraints. In particular, compared to lower frequency band systems, the coverage range in the mmWave band is limited by very high free space propagation loss, higher penetration, reflection and scattering losses and atmospheric oxygen absorption that will be experienced by communication carrier waves operating within this spectrum.

To overcome potentially huge path losses that may be experienced when implementing, for example, a 60 GHz radio architecture, beamforming techniques may become very important for adjusting multi-element antenna systems at both the transmission and reception sides. As a result, beamforming techniques are required with the objective of transmitting and receiving towards the best beam-direction in order to maximize the signal to noise ratio (SNR) for single spatial data stream. Given the much smaller wavelength (e.g., 5 mm for 60 GHz) in this band, to extend the range of coverage, antenna systems may be equipped with beam steering capability to focus in the best direction(s) for transmission and reception.

Very High Throughput WLAN (VHT WLAN) systems are designed for increased data throughputs over the air using directional links. However, the devices need to be aware of each other in the network, so omnidirectional communication, or coordinated communication (in cases where nodes can't see each other because of limited omni range) is needed between the devices during initial phases of establishment of the direct links. Further, in order to ensure that communication within the network is done in a controlled manner, there needs to be a control node that defines the “basic frames” for the communication, such as the Media Access Control (MAC) superframe structure with various allocation types.

### SUMMARY

Method, apparatus, and computer program product embodiments are disclosed to improve establishing direct links in the Contention Based Period (CPB) of the MAC superframe. Embodiments of the invention enable scheduled and unscheduled data delivery modes (DDM) for a Contention Based Period. Embodiments of the invention reuse capabilities of the private basic service set (PBSS) Control node (PCP) device like polling during announcement time (AT) period in order to identify stations that want to initiate data transmission with other stations. That knowledge may further be used by the control node (PCP) to facilitate training procedure between stations during the Contention Based Period (CPB) period or Dynamic service period (SP) periods. The behavior of stations within those periods may be divided in two phases: the training phase, referred to as the Beamforming Training Time (BFTT) and data schedule negotiation phase, referred to as the Data Delivery Mode Negotiation Time (DNT). Within the training phase, stations learn in which direction they should point their antennas and during the negotiation phase, a decision on data delivery mode is taken. Data delivery modes include mechanisms such as unscheduled delivery, scheduled delivery, or always on delivery. The phases may occur directly, one after the other, or they may be separated in time. Typically, training phase (if needed) should occur before the data negotiation phase. The beginning of the training phase or data negotiation phase (if training phase is not needed) is indicated via a meeting point identifying the time instance at which stations involved in a setup procedure should be awake.

Example embodiments of the invention comprise:

establishing a direct link in the Contention Based Period (CPB) of the MAC superframe;

enabling scheduled and unscheduled data delivery modes (DDM) for the Contention Based Period;

reusing capabilities of the private basic service set (PBSS) Control Point (PCP) polling during the announcement time (AT) period in order to identify stations that want to initiate data transmission with other stations;

using knowledge of the identified stations to facilitate training procedure between stations through the Contention Based Period (CPB) period or Dynamic service period (SP) periods;

wherein the behavior of the stations within those periods is divided into a Beamforming Training Time (BFTT) and a Data Delivery Mode Negotiation Time (DNT); and

wherein in the training phase, a station learns in which direction to point its antenna and during the negotiation phase, a decision on data delivery mode is taken.

Example embodiments of the invention comprise:

transmitting, by a first node, at least one announcement frame to a control node during a dedicated announcement time period within a superframe of a communication medium to indicate need to initiate direct link data transmission with a second node, wherein the announcement frame includes information identifying the first and the second nodes;

receiving an indication of possible reception of an announcement reply frame at a later time (or) actual reception of at least one announcement reply frame from the control node during the dedicated announcement time period, wherein the announcement reply frame indicates allocation of a meeting point time period within a contention based period of the superframe;

initiating communication establishment procedure including contention for accessing the communication medium at the meeting point time period; and

when access to the communication medium is gained, initiating beamforming training phase or message exchange to learn in which is the optimal direction of transmission and receiving for performing direct link communication with the second node.

The allocation may be zero offset, wherein no timing information is included in the announcement reply. The allocation may be offset based, wherein timing information is included in announcement reply. The allocation may be service period based, wherein timing and duration information are included in the announcement reply. A data delivery mode negotiation may be performed after the beamforming training phase.

Example embodiments of the invention comprise:

receiving at a control node, at least one announcement frame from a first node during a dedicated announcement time period within a superframe of a communication medium to indicate need to initiate direct link data transmission with a second node, wherein the announcement frame includes information identifying the first and the second nodes; and

transmitting by the control node at least one announcement reply frame during the dedicated announcement time period, wherein the announcement reply frame indicates an allocation of a meeting point time period within a contention based period of the superframe.

The resulting example embodiments provide improved techniques to establish direct links in the Contention Based Period (CPB) of the MAC superframe.

The above summarized configurations or operations of various embodiments of the present invention have been provided merely for the sake of explanation, and therefore, are not intended to be limiting. Moreover, inventive elements associated herein with a particular example embodiment of the present invention can be used interchangeably with other example embodiments depending, for example, on the manner in which an embodiment is implemented.

### DESCRIPTION OF THE FIGURES

FIG. 1 is an example network diagram of components of a private basic service set (PBSS).

FIG. 2A is an example timing diagram of beacon interval (BI) structure for Next Generation millimeter wave Standardization (NGmS) system with Contention Based Period (CPB) channel time allocation only.

FIG. 2B is an example timing diagram of general NGmS BI structure including possible channel type allocations.

FIG. 3 is an example timing diagram of meeting point and BI structure for zero offset case with meeting point occurring within CBP with private basic service set (PBSS) Control Point (PCP) in awake state according to an embodiment.

FIG. 4 is an example timing diagram of meeting point and BI structure for zero offset case with meeting point occurring within CBP with PCP in doze state according to an embodiment.

FIG. 5 is an example timing diagram of meeting points and BI structure for offset based case according to an embodiment.

FIG. 6 is an example timing diagram of meeting points scheduled during the dynamic SP periods according to an embodiment.

FIG. 7 is an example timing diagram of beamforming training time (BFTT) and data delivery mode (DDM) negotiation time (DNT) phases occurring together within the CBP with PCP in awake state according to an embodiment.

FIG. 8 is an example timing diagram of BFTT and DNT phases occurring in a separate CBP periods with indication of DNT start time according to an embodiment.

FIG. 9 is an example timing diagram of BFTT and DNT phases occurring together within the CBP with PCP in doze state according to an embodiment.

FIG. 10 is an example timing diagram of BFTT and DNT phases occurring together during the dynamic SP period according to an embodiment.

FIG. 11 is an example timing diagram of BFTT phase occurring in a dynamic SP period and DNT phases occurring in a CBP period with PCP in doze state according to an embodiment.

FIG. 12 is an example timing diagram of where the AT period is not present in the BI and the PCP cannot explicitly indicate the stations that have to be awake during the CBP period according to an embodiment.

FIG. 13 illustrates an external view and a functional block diagram of an example embodiment of the wireless device.

FIG. 14 is an example flow diagram of operational steps of a station transmitting an announcement frame to another station functioning as a control node during a dedicated announcement time period and receiving an announcement reply frame from the control node according to an embodiment of the invention.

FIG. 15 is an example flow diagram of operational steps of a station functioning as a control node receiving an announcement frame from a station during a dedicated announcement time period and transmitting an announcement reply frame to the station according to an embodiment of the invention.

### DISCUSSION OF EXAMPLE EMBODIMENTS OF THE INVENTION

U.S. patent application Ser. No. 12/118,207 to Naveen Kakani and Jakub Majkowski, filed May 9, 2008, entitled “Power Save Mechanism For Wireless Communication Devices”, is incorporated herein by reference for its disclosure of various related power save modes of operation between wireless devices.

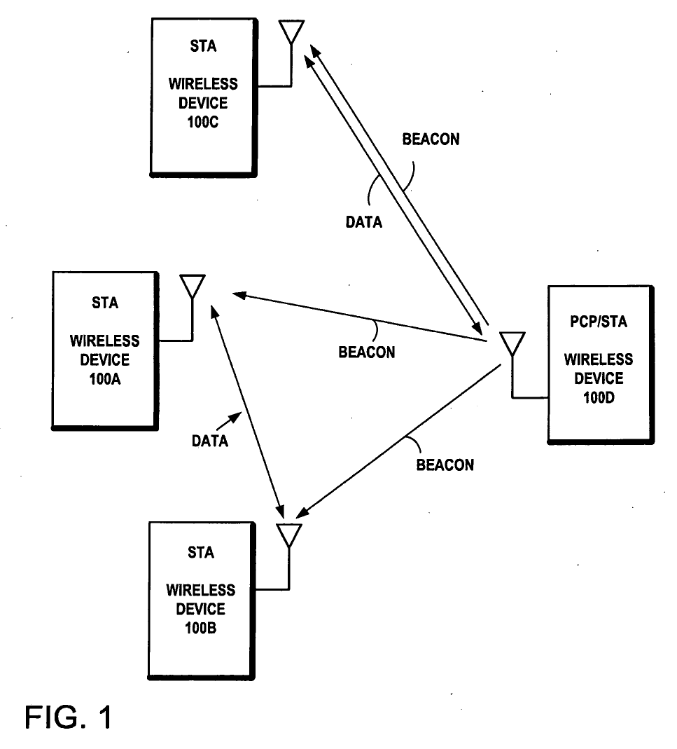

FIG. 1 is an example network diagram of components of a private basic service set (PBSS). A PBSS is a wireless ad hoc data communications system which allows a number of independent data stations (STAs) to communicate with each other. It is a logical entity and not a physical entity simply determined by propagation characteristics. A PBSS is distinguished from other types of data networks in that communications are normally confined to a small area around person or object whether the STAs are stationary or in motion. PBSSs form without planning and for only as long as the PBSS is needed, hence they are often described as an ad hoc network.

A PBSS consists of several components, as shown in FIG. 1. The basic component is the STA, of which four are shown, 100A, 100B, 100C, and 100D. One STA is required to assume the role of the PBSS central point (PCP), which in the case of FIG. 1 is the STA 100D. The PCP provides the basic timing for the PBSS through the beacons and announcement frames. Additionally, the PCP manages the quality of service (QoS), beamforming, spatial reuse, power management, and access control features of the PBSS.

A PBSS is formed when a STA that is capable of acting as the PCP begins transmitting beacons. Thus, even if there are no associated STAs, the PCP sending beacons represents a PBSS. One of the primary functions of the PCP is to transmit a beacon with appropriate information about the PBSS.

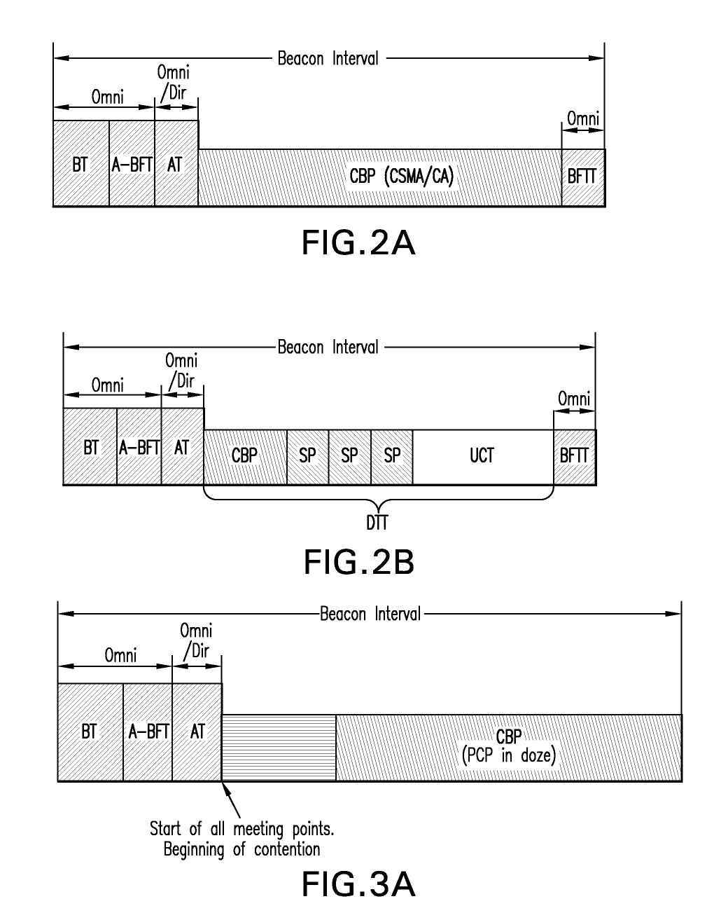

It has been proposed that the MAC superframe structure could consist only of Contention Based Period (CBP), see example FIG. 2A. The approach of channel access relying only on CBP may be advantageous as it may result in lower complexity of a device being the private basic service set (PBSS) Control Point (PCP). However, there may arise a need for power save data delivery during the CBP period. There is little or no power savings when all nodes that declared the need to use CBP periods are required to be awake during entirety of all CBP periods. Moreover, if collision resolution and access granting were to be done by the PCP, it implicitly requires the PCP to stay awake during the CBP periods. Although this type of communication logic may be suitable for a system where CBP is not a dominant channel access method, it is not scalable to a case where CBP is the only channel access method. In case of the MAC superframe with CBP access only, each device would need to stay awake during the entire beacon interval resulting in high power consumption.

According to an embodiment, channel access may be based on TDMA schedules with three different channel time allocations, namely: Contention Based Period, Service Period, and Unallocated Channel Time (UCT). The number of time slots for each period is provided by the PCP. An example MAC superframe structure with all three time allocations is shown in FIG. 2B. The order and number of different allocation times is variable and may be decided by the PCP. (The UCT is a time period during which data delivery is dynamically scheduled by the PCP with schedules being distributed during the UCT time (SP extension, DBM) otherwise it is idle time, no channel access is possible.) To use CBP periods stations inform the PCP through a message exchange during Announcement Time (AT) period that typically precedes Data Transfer Time (DTT) as shown e.g. on the example FIG. 2B. During CBP periods scheduled stations are required to be awake during all scheduled CBP periods. The channel access within the CBP is based on the carrier sense, multiple access/collision avoidance (CSMA/CA) rules. Each data transmission within the CBP has to be preceded by request to send/clear to send (RTS/CTS) exchange with the PCP. According to an example scenario, if STA1 and STA3 want to send data to STA2 during CBP period they first have to go through the backoff process. If they happened to defer for the same number of slots N, then after the Nth slot they transmit RTS frames to the PCP. If the PCP managed to resolve the apparent collision of RTS frames from STA1 and STA3 it grants channel access to one of the STAs. The grant is conveyed through the CTS frame transmitted in omni-directional way, with destination address set to the address of one of the contending STAs and network allocation vector (NAV) value set to expected data transmission duration stated within the RTS frame received from that STA.

By including RTS/CTS exchange with the PCP prior to each data transmission and because of the obligation of all STAs to stay awake during the entire CBP duration the distribution of information of medium occupancy among all the stations within the CBP may be achieved. Therefore a sort of resource reservation may be reached.

Nevertheless, operational assumptions considered for situation when CBP periods are just minor allocation time periods within MAC superframe structure are not scalable to schemes where CBP is the only type of channel access method during MAC superframe. The problems that may arise are connected to energy efficiency of non-PCP as well as PCP stations.

Proposals for Non-PCP STA power save mode using power management bit (similar to the IEEE 802.11 standard) only allow a STA to indicate to the PCP what number of Target Beacon Transmission Time (TBTT)s during which the STA will be asleep, thus the PCP shouldn't provide any schedules for that STA during that time. The Non-PCP STA power save mode is a kind of macro level mechanism. However, as data delivery is done on per link basis a micro level mechanism for link specific power save delivery is required.

Embodiments of the invention provide a protocol enabling scheduled and unscheduled data delivery modes (DDM) (like e.g. scheduled automatic power save delivery (S-APSD) and unscheduled automatic power save delivery (U-APSD) defined in the IEEE 802.11) for a Contention Based Period. Embodiments of the invention provide a mechanism that reuses capabilities of the PCP device like polling during the AT period in order to identify stations that want to initiate data transmission with other stations. This knowledge is used by the PCP to facilitate beamforming training procedure between stations through the CBP period or Dynamic SP periods. The behavior of stations within those periods is divided in two phases: the training phase (BFTT—Beamforming Training Time) and data schedule negotiation phase (DNT—Data Delivery Mode Negotiation Time). Within the training phase, stations may learn in which direction they should point their antennas and during negotiation phase, a decision on data delivery mode is taken. Data delivery modes include mechanisms like: unscheduled delivery, scheduled delivery or always on delivery.

The phases may occur directly one after the other or may be separated in time. Typically, training phase (if needed) occurs before the data negotiation phase. The beginning of the training phase or data negotiation phase (if training phase is not needed) is indicated via a meeting point. The meeting point is a time based reference identifying the time instance at which stations involved in a setup procedure should be awake.

Embodiments of the invention may be divided into three parts:

Part 1—concerns the changes to Announce Time (AT) period operation

Part 2—is related to different ways of meeting point management

Part 3—deals with procedures for BFTT and DNT phases operation

### Part 1 AT Period Operation Embodiments

During the AT period the station being polled may indicate to the PCP with the CBP Announcement frame if it wants to initiate a transmission with some other station. The example of a frame body according to at least one embodiment of a CBP Announcement frame is shown in Table 1.

TABLE 1
Frame body of CBP announcement

| Order | Information | Octets |
|---|---|---|
| 1 | STA ID List | 64 |

After reception of CBP Announcement frame and ensuring that both the STAs are awake, the PCP transmits CBP Announcement reply frame to involved stations, providing meeting point details, in order to assure that they will be awake at the same time to initiate communication. Depending on BI structure the meeting point may correspond to current BI or the following one.

Moreover a meeting point may be specified differently in case it is used during CBP with PCP marked as available, CBP with PCP marked as unavailable or dynamic SP. Exemplary frame bodies of different CBP announcement reply frame for different meeting point specification are shown in Tables 2-4.

Table 2 shows an example frame body according to at least one embodiment that may be used in situation when meeting point start right after the beginning of the CBP period (zero offset case). In embodiments, the destination station may be specified by the AID. In other embodiments, the destination station may be specified by the MAC address.

TABLE 2
Frame body of CBP announcement reply

| Order | Information | Octets |
|---|---|---|
| 1 | Src STA ID | 1-6 |
| 2 | Dest STA | 1-6 |
| | ID | |

Table 3 shows an example frame body according to at least one embodiment including the time instant at which STAs have to be awake. Table 4 shows exemplary information that may be used for dynamic SP allocation according to at least one embodiment. More details on the role of frames is given in part 2.

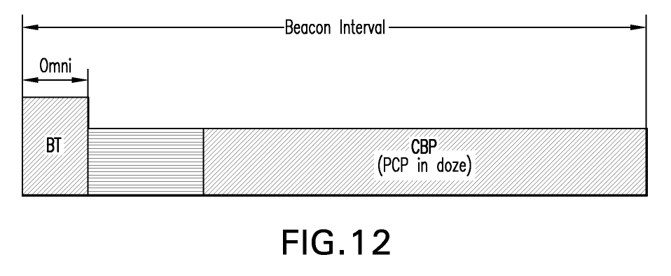

In accordance with at least one alternative embodiment where the announcement time (AT) period is not present in the BI, the PCP cannot explicitly indicate the stations that have to be awake during the CBP period. Therefore in accordance with such an embodiment all stations for which the current BI is an Awake BI should be awake during the CBP with PCP marked as available. Consequently, stations will be able to communicate with each other and decide on the meeting point even though they were not explicitly requested by the PCP to be awake. An example FIG. 12 describes an example BI structure for this type of an embodiment.

### Part 2 Meeting Point Management Embodiments

When meeting points are defined for CBP period two different ways of specifying them may be utilized:

1. Zero offset embodiment

2. Offset based embodiment

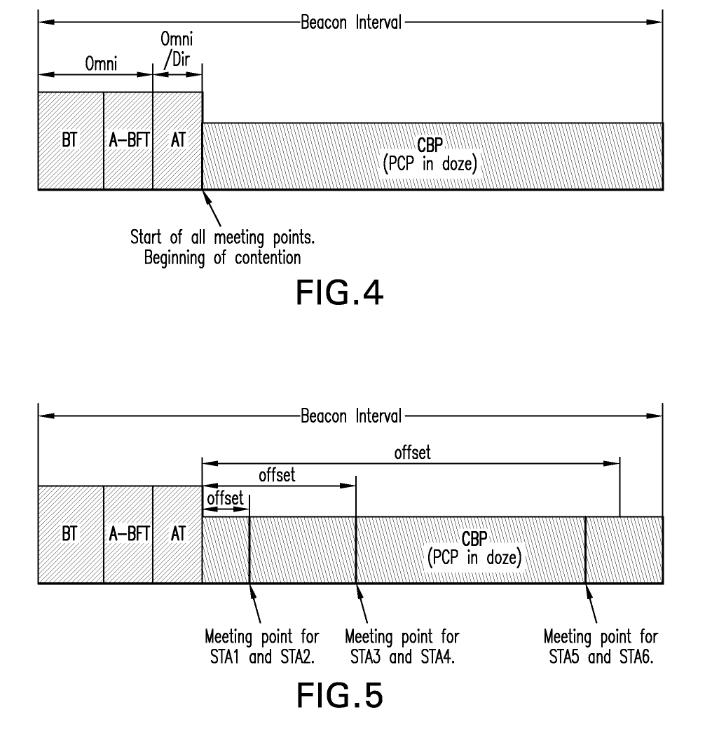

The zero offset embodiment requires that each station that wants to initiate new communication needs to be awake directly from the beginning of a CBP period. Therefore the meeting point does not provide any start time as all stations contend from the beginning of the CBP period. During the CBP the PCP may be awake or in doze state hence resulting in different access procedure, described in Part 3. Exemplary BI structures according to some embodiments are shown in FIG. 3 and FIG. 4. The CBP announcement reply frame that may used in connection with those embodiments is shown in Table 1.

In case of offset based embodiment interested stations need be awake during the CBP period at indicated meeting point time instant. Provided meeting point may specify time offset with respect to any common reference point like: BT, A-BFT, AT or the beginning of the CBP period depending on the embodiment. In contrast to scheduled times like dynamic SP the meeting point does not guarantee that the medium will be free at that indicated time but it just assures that interested stations will be awake at the same time. The stations follow the CBP access rules once they are awake at the meeting point. The example CBP announcement reply frame that may be used in connection with such embodiment is shown in Table 3. In embodiments, the destination station may be specified by the AID. In other embodiments, the destination station may be specified by the MAC address. Exemplary BI structure is shown in FIG. 5.

TABLE 3
Frame body of CBP announcement reply

| Order | Information | Octets |
|---|---|---|
| 1 | Src STA ID | 1-6 |
| 2 | Dest STA ID | 1-6 |
| 3 | Meeting point location | 2 |

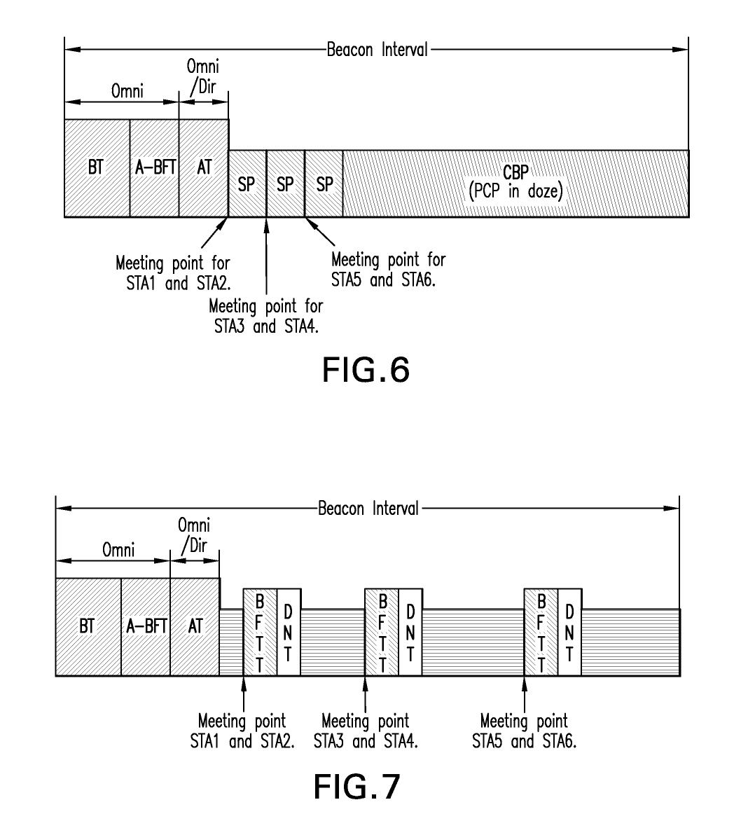

Meeting points may also be scheduled during the dynamic SP periods hence channel time allocation frame can be employed to conveyed duration and location of reserved time slots. Typically frame body of channel time allocation would include information as shown in Table 4. In embodiments, the destination station may be specified by the AID. In other embodiments, the destination station may be specified by the MAC address. Exemplary BI structure that may be used in connection with such embodiment is shown in FIG. 6.

TABLE 4
Exemplary frame body for dynamic SP allocation

| Order | Information | Octets |
|---|---|---|
| 1 | Src STA ID | 1-6 |
| 2 | Dest STA | 1-6 |
| | ID | |
| 3 | SP duration | 2 |
| 4 | SP location | 2 |

### Part 3 Embodiments Relating to Operation of BFTT and DNT Phases

In embodiments where a meeting point is within CBP period the BFTT phase and DNT phase may directly follow one another or be separated to different CBP periods. Different CBP period may be defined depending on the power management state of the PCP.

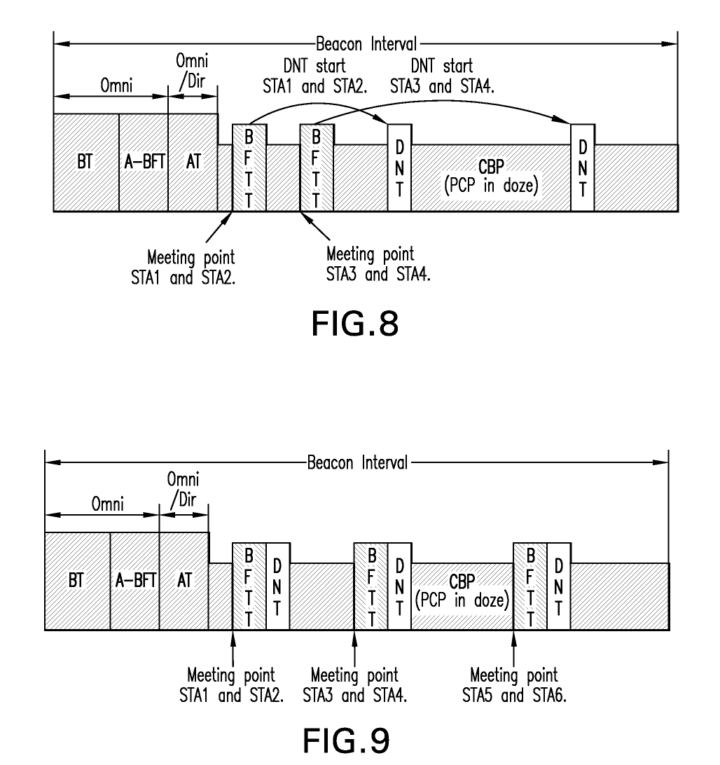

Within the CBP period, with PCP marked as available, the station identified as a source station in the CBP announcement frame or the station that want to start new communication in connection with the embodiment of BI without an AT period contend for the medium in order to start BFTT phase. The contention may be based on a backoff process and RTS/CTS exchange with the PCP. After the channel is granted through the CTS frame the source station may start its training procedure. Depending on BI period organization the BFTT phase may be directly followed by the DNT phase according to some embodiments, see FIG. 7 or DNT may happen in different CBP period, see FIG. 8. Advantages of the offset based meeting point scheme and the service period based embodiment include timing for allocated nodes to be active, power saving possibility to the rest of the CBP and potentially collision free channel access.

According to at least one embodiment, if DNT happens in different CBP the source station during the BFTT phase has to
indicate the time instant at which both stations should be awake to perform data schedule negotiation if the PCP is unavailable during that CBP period, or
indicate the beginning of the next CBP period with PCP marked as available state where DNT may happen.

Therefore a source station may provide corresponding time instant as an offset to the beginning of the new CBP period. According to at least one embodiment, if during the BFTT multiple stations are trained the source station should:
provide separate DNT time instants for each station if only destination station is trained
initiate data schedule negotiation at the beginning of DNT

Within the CBP period with PCP marked as unavailable the station identified as a source station in the CBP announcement frame contend for the medium in order to start BFTT phase. The contention as in previous case is based on backoff procedure but the RTS/CTS exchange may be done directly with interested stations not the PCP. In situation with CBP period with PCP being in doze state both zero offset and offset based schemes applies and BFTT is followed by DNT phase according to at least one embodiment, see FIG. 9.

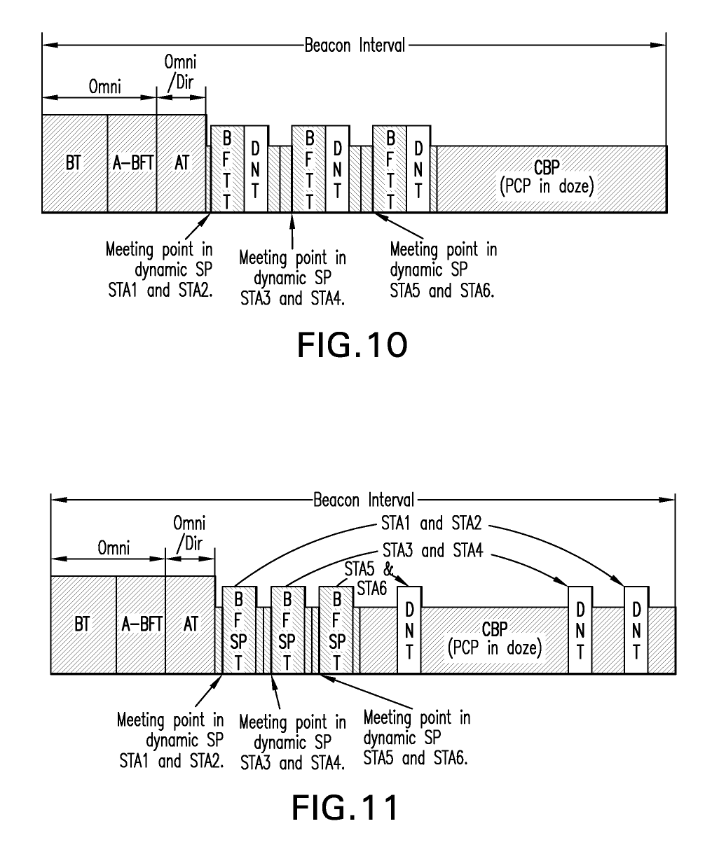

According to an embodiment where a meeting point is a part of dynamic SP than either both phases BFTT and DNT may happen within that scheduled time, see FIG. 10, or DNT may be done in subsequent CBP period, see FIG. 11. According to at least one embodiment, in case the DNT is to be performed during the CBP period the BFTT procedure should include the information indicating:
the time instant at which both stations should be awake to perform data schedule negotiation if the PCP is marked unavailable during that CBP period, or
indicate the beginning of the next CBP period with PCP marked as available where DNT may happen.

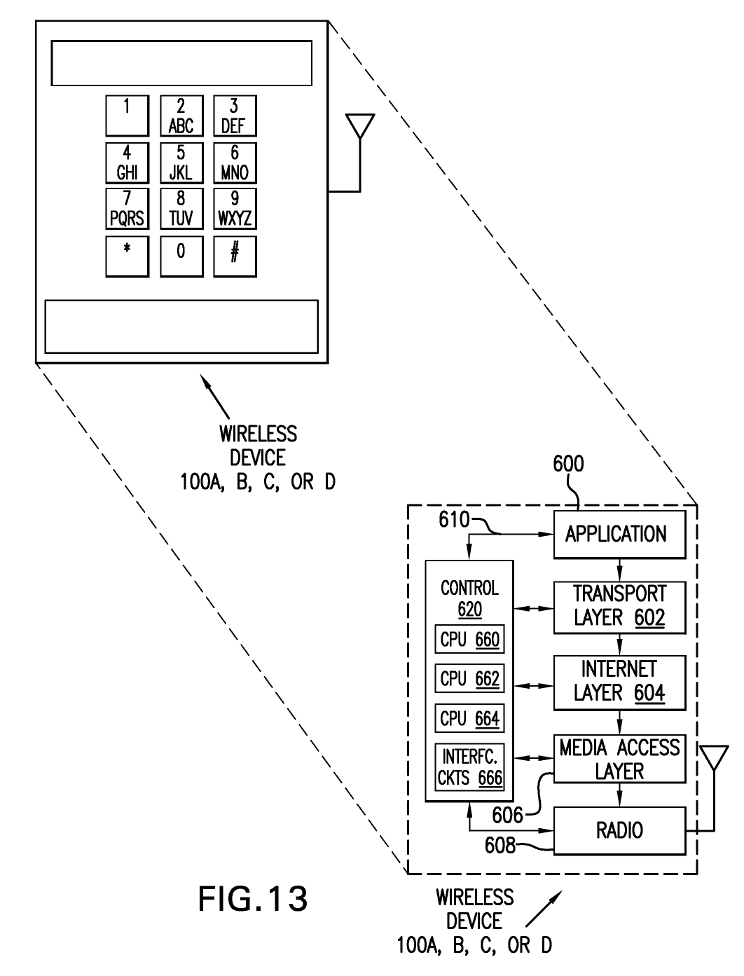

FIG. 13 illustrates an external view and a functional block diagram of an example embodiment of any one of the wireless devices (STA) 100A, 100B, 100C, and 100D shown in the PBSS of FIG. 1. For example, the wireless device 100A may be a communications device, PDA, cell phone, laptop or palmtop computer, or the like. The wireless device 100A includes a control module 620, which includes a central processing unit (CPU) 660, a random access memory (RAM) 662, a read only memory (ROM) 664, and interface circuits 666 to interface with the radio transceiver 608, battery and other power sources, key pad, touch screen, display, microphone, speakers, ear pieces, camera or other imaging devices, etc. in the devices 100A, 100B, and 100C. The RAM 662 and ROM 664 can be removable memory devices such as smart cards, SIMs, WIMs, semiconductor memories such as RAM, ROM, PROMS, flash memory devices, etc. The wireless device 100A includes for example an Internet protocol stack that includes the user's application program 600 at the top, the Transmission Control Protocol (TCP) transport layer 602, and the Internet Protocol (IP) layer 604, the Media Access Control (MAC) layer 606, and the radio transceiver physical layer 608 at the bottom of the protocol stack. The 802.11 MAC layer provides functionality to allow reliable data delivery for the upper layers over the wireless medium.

The control module 620, internet protocol stack layers 602, 604, 606, and/or application program 600 can be embodied as program logic stored in the RAM 662 and/or ROM 664 in the form of sequences of programmed instructions which, when executed in the CPU 660, carry out the functions of the disclosed embodiments. The program logic can be delivered to the writeable RAM, PROMS, flash memory devices, etc. 662 of the wireless device 100A from a computer program product or article of manufacture in the form of computer-usable media such as resident memory devices, smart cards or other removable memory devices, or in the form of program logic transmitted over any transmitting medium which transmits such a program. Alternately, they can be embodied as integrated circuit logic in the form of programmed logic arrays or custom designed application specific integrated circuits (ASIC). The radio 608 in wireless device 100A can be separate transceiver circuits or alternately, the radio 608 can be a single radio module capable of handling one or multiple channels in a high speed, time and frequency multiplexed manner in response to the control module 620.

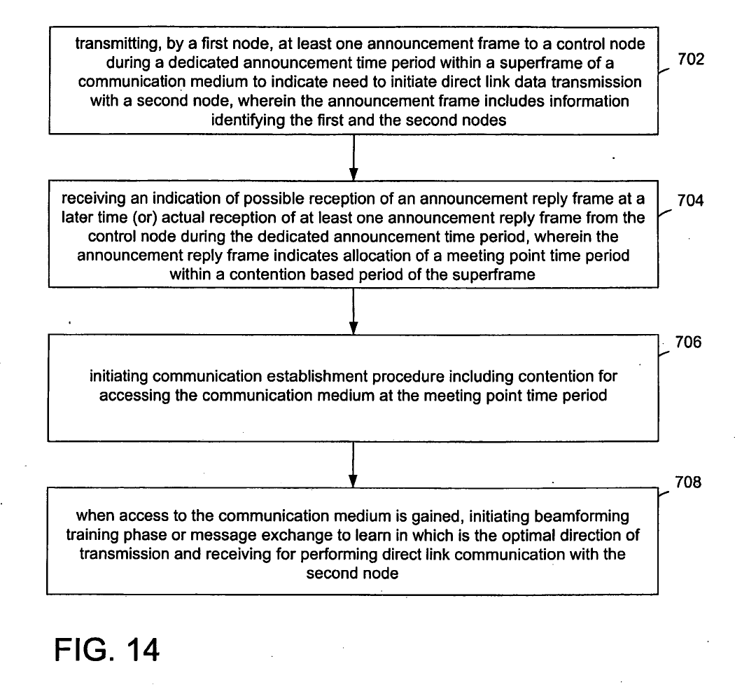

FIG. 14 is an example flow diagram of operational steps of a station transmitting an announcement frame to another station functioning as a control node during a dedicated announcement time period and receiving an announcement reply frame from the control node according to an embodiment of the invention. The sequence of steps follows.

Step 702 is transmitting, by a first node, at least one announcement frame to a control node during a dedicated announcement time period within a superframe of a communication medium to indicate need to initiate direct link data transmission with a second node, wherein the announcement frame includes information identifying the first and the second nodes.

Step 704 is receiving an indication of possible reception of an announcement reply frame at a later time (or) actual reception of at least one announcement reply frame from the control node during the dedicated announcement time period, wherein the announcement reply frame indicates allocation of a meeting point time period within a contention based period of the superframe.

Step 706 is initiating communication establishment procedure including contention for accessing the communication medium at the meeting point time period.

Step 708 is when access to the communication medium is gained, initiating beamforming training phase or message exchange to learn in which is the optimal direction of transmission and receiving for performing direct link communication with the second node.

The allocation may be zero offset, wherein no timing information is included in the announcement reply. The allocation may be offset based, wherein timing information is included in announcement reply. The allocation may be service period based, wherein timing and duration information are included in the announcement reply. A data delivery mode negotiation may be performed after the beamforming training phase.

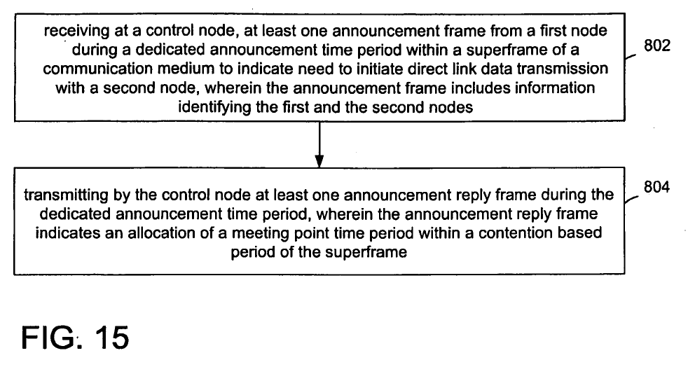

FIG. 15 is an example flow diagram of operational steps of a station functioning as a control node receiving an announcement frame from a station during a dedicated announcement time period and transmitting an announcement reply frame to the station according to an embodiment of the invention. The sequence of steps follows.

Step 802 is receiving at a control node, at least one announcement frame from a first node during a dedicated announcement time period within a superframe of a communication medium to indicate need to initiate direct link data transmission with a second node, wherein the announcement frame includes information identifying the first and the second nodes.

Step 704 is transmitting by the control node at least one announcement reply frame during the dedicated announcement time period, wherein the announcement reply frame indicates an allocation of a meeting point time period within a contention based period of the superframe.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
transmitting, by a first node, at least one announcement frame to a control node during a dedicated announcement time period within a superframe of a communication medium to indicate need to initiate direct link data transmission with a second node, wherein the announcement frame includes information identifying the first and the second nodes;
receiving an indication of at least one announcement reply frame from the control node during the dedicated announcement time period, wherein the announcement reply frame indicates allocation of a meeting point time period within a contention based period of the superframe;
initiating communication establishment procedure including contention for accessing the communication medium at the meeting point time period; and
when access to the communication medium is gained, initiating beamforming training phase or message exchange to learn direction of transmission and receiving for performing direct link communication with the second node.

2. The method of claim 1, which further comprises: said allocation is zero offset, wherein no timing information included in the announcement reply.

3. The method of claim 1, which further comprises: said allocation is offset based, wherein timing information included in announcement reply.

4. The method of claim 1, which further comprises: said allocation is service period based, wherein timing and duration information are included in the announcement reply.

5. The method of claim 1, which further comprises: performing data delivery mode negotiation after said beamforming training phase.

6. A method, comprising:
receiving at a control node, at least one announcement frame from a first node during a dedicated announcement time period within a superframe of a communication medium to indicate need to initiate direct link data transmission with a second node, wherein the announcement frame includes information identifying the first and the second nodes; and
transmitting by the control node at least one announcement reply frame during the dedicated announcement time period, wherein the announcement reply frame indicates an allocation of a meeting point time period within a contention based period of the superframe.

7. The method of claim 6, which further comprises: said allocation is zero offset, wherein no timing information included in the announcement reply.

8. The method of claim 6, which further comprises: said allocation is offset based, wherein timing information included in announcement reply.

9. The method of claim 6, which further comprises: said allocation is service period based, wherein timing and duration information are included in the announcement reply.

10. The method of claim 6, wherein the first node and the control node may switch their respective roles.

11. A device, comprising:
a transceiver; and
a processor configured to control the operation of the transceiver to:
transmit, by the device, at least one announcement frame to a control node during a dedicated announcement time period within a superframe of a communication medium to indicate need to initiate direct link data transmission with a second device, wherein the announcement frame includes information identifying the device and the second device;
receive an indication of at least one announcement reply frame from the control node during the dedicated announcement time period, wherein the announcement reply frame indicates allocation of a meeting point time period within a contention based period of the superframe;
initiate communication establishment procedure including contention for accessing the communication medium at the meeting point time period; and
when access to the communication medium is gained, initiate beamforming training phase or message exchange to learn direction of transmission and receiving for performing direct link communication with the second device.

12. The device of claim 11, which further comprises: said allocation is zero offset, wherein no timing information included in the announcement reply.

13. The device of claim 11, which further comprises: said allocation is offset based, wherein timing information included in announcement reply.

14. The device of claim 11, which further comprises: said allocation is service period based, wherein timing and duration information are included in the announcement reply.

15. The device of claim 11, which further comprises: said processor configured to control the operation of the transceiver to: perform data delivery mode negotiation after said beamforming training phase.

16. A device, comprising:
a transceiver; and
a processor configured to control the operation of the transceiver to:
receive at the device, at least one announcement frame from a first node during a dedicated announcement time period within a superframe of a communication medium to indicate need to initiate direct link data transmission with a second node, wherein the announcement frame includes information identifying the first and the second nodes; and
transmit by the device at least one announcement reply frame during the dedicated announcement time period, wherein the announcement reply frame indicates an allocation of a meeting point time period within a contention based period of the superframe.

17. The device of claim 16, which further comprises: said allocation is zero offset, wherein no timing information included in the announcement reply.

18. The device of claim 16, which further comprises: said allocation is offset based, wherein timing information included in announcement reply.

19. The device of claim 16, which further comprises: said allocation is service period based, wherein timing and duration information are included in the announcement reply.

20. The device of claim 16, wherein the first node and the device may switch their respective roles.

21. A computer readable medium, comprising:
a computer readable medium configured to store program instructions, which when executed by a computer processor, perform the steps of:
transmitting, by a first node, at least one announcement frame to a control node during a dedicated announcement time period within a superframe of a communication medium to indicate need to initiate direct link data transmission with a second node, wherein the announcement frame includes information identifying the first and the second nodes;
receiving an indication of at least one announcement reply frame from the control node during the dedicated announcement time period, wherein the announcement reply frame indicates allocation of a meeting point time period within a contention based period of the superframe;
initiating communication establishment procedure including contention for accessing the communication medium at the meeting point time period; and
when access to the communication medium is gained, initiating beamforming training phase or message exchange to learn direction of transmission and receiving for performing direct link communication with the second node.

22. A computer readable medium, comprising:
a computer readable medium configured to store program instructions, which when executed by a computer processor, perform the steps of:
receiving at a control node, at least one announcement frame from a first node during a dedicated announcement time period within a superframe of a communication medium to indicate need to initiate direct link data transmission with a second node, wherein the announcement frame includes information identifying the first and the second nodes; and
transmitting by the control node at least one announcement reply frame during the dedicated announcement time period, wherein the announcement reply frame indicates an allocation of a meeting point time period within a contention based period of the superframe.
